(19) United States
(12) Patent Application Publication
(10) Pub. No.: US 2014/0289377 A1
(43) Pub. Date: Sep. 25, 2014

(54) CONFIGURING NETWORK STORAGE SYSTEM OVER A NETWORK

(71) Applicant: NETAPP INC., Sunnyvale, CA (US)

(72) Inventors: Eric Peter Dutko, Hillsborough, NC (US); Christopher John Lueth, San Ramon, CA (US); Timothy Eric Nicholson, Raleigh, NC (US); Jeffrey Alan Fultz, El Dorado Hills, CA (US); Brian Hackworth, Fillmore, CA (US)

(73) Assignee: NetApp Inc., Sunnyvale, CA (US)

(21) Appl. No.: 13/849,156

(22) Filed: Mar. 22, 2013

(51) Int. Cl. H04L 12/24

(52) U.S. Cl. CPC H04L 41/0803
USPC 709/220

(57) ABSTRACT

Network storage system configuration via a network is disclosed. An IP assignment component is configured to listen for IP assignment requests over the network. Responsive to identifying an IP assignment request originating from a network storage system, the IP assignment component assigns an IP address to the network storage system, and provides configuration access to the network storage system based upon the IP address. A network device management component is configured to send identification requests over the network. Responsive to receiving a response from a network storage system having a previously assigned IP address, the network device management component provides configuration access to the network storage system based upon the previously assigned IP address. In this manner, a network storage system is (e.g., remotely) configured (e.g., over a network), rather than a technician having to physically connect (e.g., via a serial cable) to the network storage system.

### BACKGROUND

One or more client devices may connect to one another over a network. For example, employees of a company may connect to a company network to access company resources, such as a database server or an email server. The network may comprise network storage, such as a network storage system comprising one or more storage devices (e.g., a storage controller comprising one or more storage drives). When a network storage system is installed on the network, the network storage system may initially lack a configuration that may otherwise allow the network storage system to operate over the network. For example, the network storage system may lack an IP address, a system name, a domain name, network interface information, domain name server (DNS) information, data volumes, etc. If the network does not comprise a dynamic host control protocol (DHCP) server capable of assigning IP addresses to devices on the network, then IP assignment requests (e.g., a request seeking an assignment of an IP address) sent over the network by the network storage system may go unanswered. Without an IP address, a configuration tool (e.g., a configuration software application hosted on an IT administrator computer or any other computing device on the network) may be unable to access the network storage system for configuration. Thus, if the network does not comprise a DHCP server, then a user, such as IT administrator or network specialist, may have to physically connect to the network storage system, such as through a serial cable, to configure the network storage system. If the network storage system does not comprise a configuration user interface, then the configuration may have to be done through command line instructions, which may be unintuitive and/or complex.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of configuring a network storage system within a network.

FIG. 4 is a component block diagram illustrating an exemplary system for configuring a network storage system within a network.

FIG. 5 is a component block diagram illustrating an exemplary system for configuring one or more network storage systems within a network.

FIG. 6 is a component block diagram illustrating an exemplary system for configuring a network storage system within a network.

FIG. 7 is a component block diagram illustrating an exemplary system for configuring one or more network storage systems within a network.

FIG. 8 is an illustration of an example of network storage configuration.

FIG. 9 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

A network may comprise one or more network storage systems (e.g., a storage controller comprising one or more storage devices, such as a storage drive). When a network storage system is installed on the network, the network storage system may initially lack configuration information, such as IP address, a system name, DNS server information, storage information (e.g., a storage device may be unformatted and/or lack data volumes), etc. If the network lacks a DHCP server, then devices on the network may be unable to communicate with the network storage system. For example, a network storage configuration tool, hosted by a device on the network, may be unable to detect and/or access the network storage system in order to configure the network storage system because the network storage system lacks an IP address used for communication over the network. Thus, a system administrator may have to physically connect to the network storage system (e.g., through a serial cable) in order to configure the network storage system, such as through command line instructions.

Accordingly, one or more techniques and/or systems for configuring a network storage system over a network are provided herein. In some embodiments, a storage system configuration tool comprises an IP assignment component. In an example, the IP assignment component comprises DHCP server functionality configured to assign IP addresses to computing devices, such as network storage systems, within the network. The IP assignment component may be configured to listen for IP assignment requests over the network. However, if the network comprises an IP assignment server (e.g., a DHCP server), then the IP assignment component may refrain from listening for IP assignment requests so that the IP assignment component and the IP assignment server component do not assign conflicting and/or inconsistent IP addresses to computing devices within the network. Responsive to identifying an IP assignment request issued by a device connected to the network, the IP assignment component may determine whether the device is a network storage system. For example, the IP assignment component may evaluate a MAC address for the device to determine whether the MAC address or a portion thereof corresponds to a network storage system manufacturer code. If the device does not comprise a network storage system, then the IP assignment component may refrain from assigning an IP address to the device. If the device does comprise a network storage system, then the IP assignment component may assign an IP address to the network storage system. The IP assignment component may be configured to provide configuration access to the network storage system via a communication that utilizes the IP address. For example, a user interface may allow a user to configure various aspects of the network storage system, such as a system name, a system password, a default gateway, a domain name, a network interface, a DNS server, a storage protocol, formatting of a storage device, creation of a volume, etc. In this way, network storage configuration may be pushed to the network storage device.

In some embodiments, the storage system configuration tool comprises a network device management component. In an example, the network device management component comprises simple network management protocol (SNMP) functionality configured to scan the network (e.g., scan a range of IP addresses, such as a first 256 IP addresses in a DHCP server subnet) for a second network storage system having a previously assigned IP address (e.g., assigned by a DHCP server or manually assigned). For example, the network device management component may send one or more identification requests over the network. Responsive to receiving a response identifying a second network storage system having a previously assigned IP address, the network device management component may provide configuration access to the second network storage system via a communication that utilizes the previously assigned IP address. For example, a user interface may allow a user to configure various aspects of the second network storage system, such as a system name, a system password, a default gateway, a domain name, a network interface, a DNS server, a storage protocol, formatting of a storage device, creation of a volume, etc. In this way, network storage configuration may be pushed to the second network storage device.

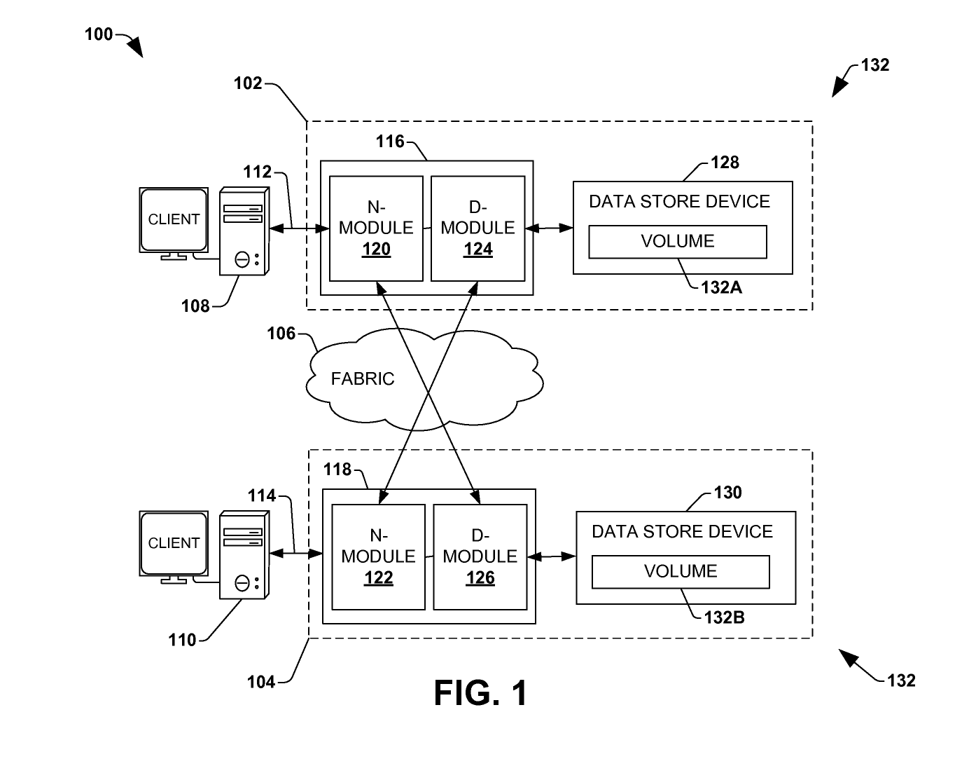

To provide context for configuring a network storage system, FIG. 1 illustrates an embodiment of a clustered network environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more clients 108, 110 which may comprise, for example, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the clients 108, 110 may be general-purpose computers running applications, and may interact with the data storage systems 102, 104 using a client/server model for exchange of information. That is, the client may request data from the data storage system, and the data storage system may return results of the request to the client via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 to connect with clients 108, 110 over the network connections 112, 114, for example, allowing the clients 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a client 108, 110 can be networked with the nodes 116, 118 in the cluster, over the networking connections 112, 114. As an example, respective clients 108, 110 that are networked to a cluster may request services (e.g., exchanging of information in the form of data packets) of a node 116, 118 in the cluster, and the node 116, 118 can return results of the requested services to the clients 108, 110. In one embodiment, the clients 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the clients 108, 110 can utilize the data storage systems 102, 104 to store and retrieve data from the volumes 132. In this embodiment, for example, the client 108 can send data packets to the N-module 120 in the node 116 within data storage system 102. The node 116 can forward the data to the data storage device 128 using the D-module 124, where the data storage device 128 comprises volume 132A. In this way, in this example, the client can access the storage volume 132A, to store and/or retrieve data, using the data storage system 102 connected by the network connection 112. Further, in this embodiment, the client 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that in one example, a storage system configuration tool may be implemented within the clustered network environment 100. For example, the storage system configuration tool may be hosted by client 108 and/or client 110. The storage system configuration tool may be configured to detect and/or configure a network storage system, such as data storage system 102 and/or data storage system 104.

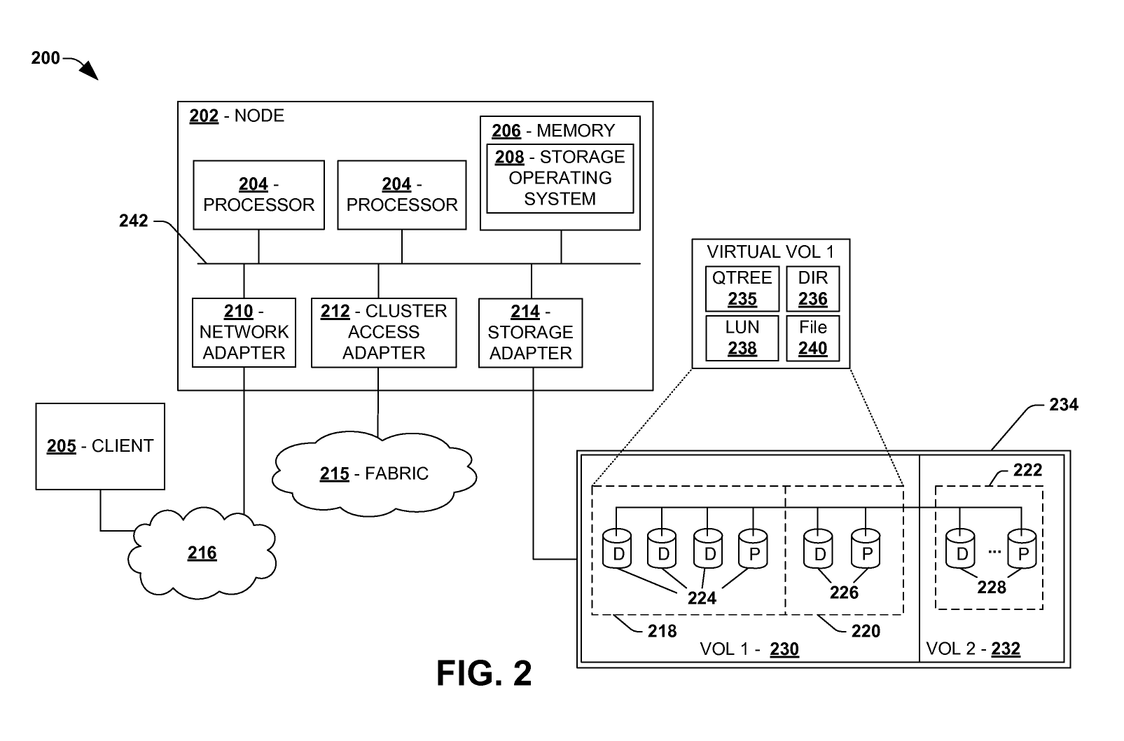

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A client 205 (e.g., 108, 110 in FIG. 1) can be connected to the node 202 over a network 216, for example, to provides access to files and/or other data stored on the data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the host 202 can respond to client requests to manage data on the data storage device 234 (e.g., or additional clustered devices) in accordance with these client requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a client 205 over a computer network 216, which may comprise, among other things, a point-to-point connection or a shared medium, such as a local area network. The client 205 (e.g., 108, 110 of FIG. 1) may be a general-purpose computer configured to execute applications. As described above, the client 205 may interact with the data storage system 200 in accordance with a client/host model of information delivery.

The storage adapter 214 cooperates with the operating system 208 executing on the host 202 to access information requested by the client 205. The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the client 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume, which may also be referred to as a “traditional volume” in some contexts, corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the host 202 connects to a volume 230, 232 through the storage adapter 214, a connection between the host 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that in one example, a storage system configuration tool may be implemented within network 216 or any other type of network (e.g., a home network, a corporate network, etc.). For example, the storage system configuration tool may be hosted by client 205. The storage system configuration tool may be configured to detect and/or configure a network storage system, such as data storage system 200 and/or node 202.

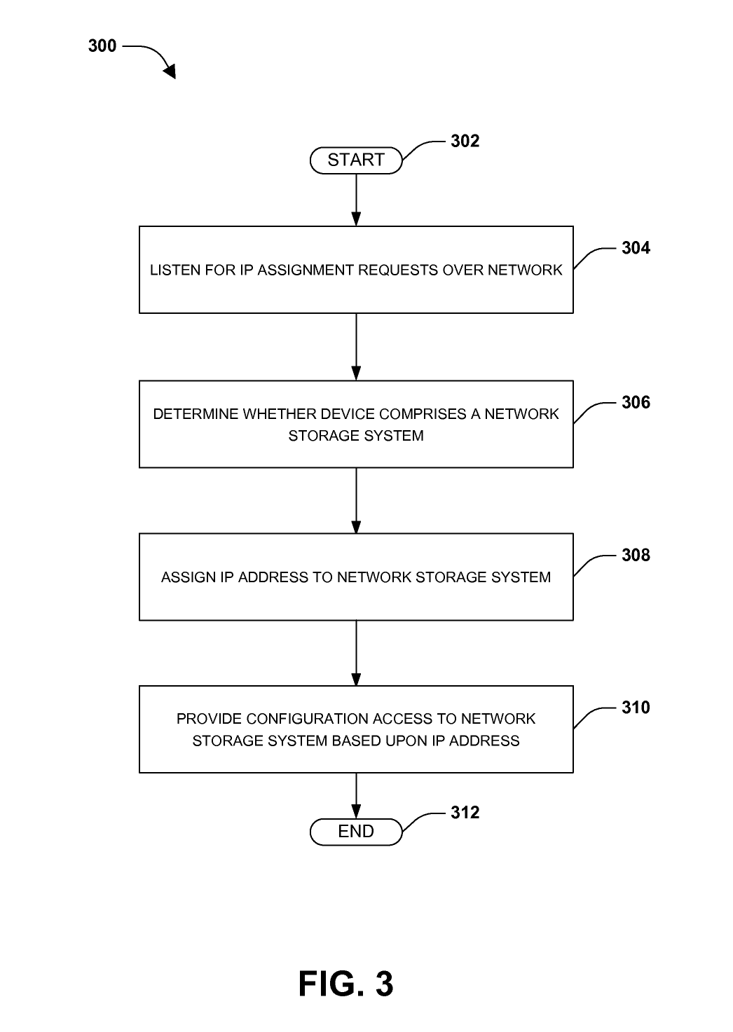

One embodiment of configuring a network storage system within a network is illustrated by an exemplary method 300 of FIG. 3. At 302, the method starts. A determination may be made as to whether a network comprises an IP assignment server, such as a DHCP server. Responsive to the network not comprising an IP assignment server, IP assignment requests are listened for over the network (e.g., using DHCP functionality associated with a storage system configuration tool, such as configuration software hosted by an IT administrator computing device connected to the network), at 304. For example, when a computing device, such as a network storage system, is connected to the network, the computing device may request an IP address for communication over the network by sending out an IP assignment request over the network. Responsive to identifying an IP assignment request that is issued by a device connected to the network, a determination may be made as to whether the device comprises a network storage system, at 306. For example, a MAC address, or the first portion of a MAC address, may be evaluated to determine whether the MAC address corresponds to a network storage system manufacturer code.

Responsive to the device comprising a network storage system (e.g., a storage controller comprising one or more storage devices), an IP address may be assigned to the network storage system, at 308. In an example, the IP address may be a temporary IP address used to facilitate communication with the network storage system, such as for configuration access used to configure the network storage system (e.g., the network storage system may be assigned a relatively more permanent IP address during configuration). At 310, configuration access may be provided to the network storage system based upon the IP address. In an example, a graphical user interface may be presented (e.g., through the IT administrator computing device), such that network storage configuration may be pushed to the network storage system over the network using the IP address. The network storage configuration may be pushed without having to utilize a local non-network connection (e.g., a serial cable). In an example, the network storage configuration may comprise a system name, a system password, a default gateway, a domain name, a network interface, a DNS server, a storage protocol, data storage information (e.g., formatting a storage device, creating a volume, etc.), and/or a variety of other configuration information. In some embodiments, an IP address save instruction may be sent to the network storage system over the network (e.g., where the IP address assigned to the network storage system is temporary), such that the network storage system is instructed to save the IP address assigned to the network storage system for utilization after a reboot. A reboot instruction may be sent to the network storage system, such that the network storage system performs a reboot in order to implement the network storage configuration information. Once rebooted, the IP address assigned to the network storage system may be utilized for communicating with the network storage system, such as by the storage system configuration tool.

In some embodiments of detecting a network storage system, one or more identification requests may be sent over the network (e.g., utilizing SNMP functionality of the storage system configuration tool). Responsive to receiving a response identifying a second network storage system having a previously assigned IP address, configuration access to the second network storage system may be provided based upon the previously assigned IP address. For example, network storage configuration information may be pushed to the second network storage device over the network (e.g., utilizing the previously assigned IP address). A reboot instruction may be sent to the second network storage device to perform a reboot in order to implement the network storage configuration information. At 312, the method ends.

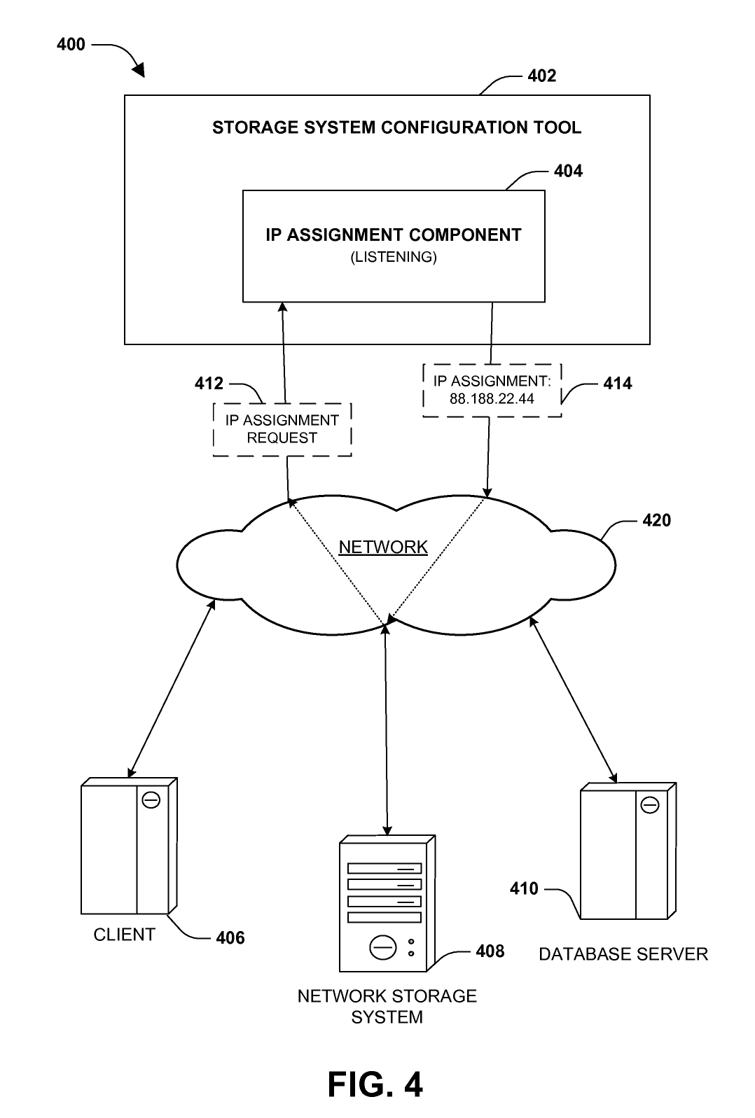

FIG. 4 illustrates an example of a system 400 for configuring a network storage system 408 within a network 420. The system 400 comprises a storage system configuration tool 402 (e.g., executing on a non-server device, a non-DHCP server device, a laptop, a mobile device, a tablet, or any other device) connected to the network 420. The storage system configuration tool 402 may comprise an IP assignment component 404. The storage system configuration tool 402 may be configured to determine whether the network 420 comprises an IP assignment server, such as a DHCP server. In instances where the network 420 does not comprise an IP assignment server, the IP assignment component 404 is invoked to listen for IP assignment requests over the network 420 (e.g., otherwise the IP assignment component 404 may refrain from listening for IP assignments so as to not conflict with the IP assignment server). In an example, the IP assignment component 404 comprises DHCP functionality configured to listen for IP assignment request and/or assign IP addresses to devices, such as the network storage system 408, within the network 420.

In an example, the network storage system 408 may lack configuration information because the network storage system 408 may have recently joined the network 420. Accordingly, the network storage system 408 may send an IP assignment request 412 over the network 420. The IP assignment component 404 may detect the IP assignment request 412, and may determine that the IP assignment request 412 originated from the network storage system 408 (e.g., as opposed to from a non-network storage system device, such as a client 406 and/or a database server 410). Because the IP assignment request 412 was issued by the network storage system 408, the IP assignment component 404 may assign an IP address (e.g., IP assignment 414 of 88.188.22.44) to the network storage system 408. The IP address may be used to provide configuration access to the network storage system 408. For example, the storage system configuration tool 402 may provide a user interface through which configuration information may be specified, such as a system name, a system password, a default gateway, a domain name, a network interface, a DNS server, a storage protocol, etc. In this way, network storage configuration may be pushed to the network storage system 408. An IP address save instruction may be pushed to the network storage system 408, which may instruct the network storage system 408 to save the IP address for further communication after a reboot. A reboot instruction may be sent to the network storage system 408 so that the network storage system 408 performs a reboot in order to implement the network storage configuration. The saved IP address may be used for further communication between the network storage system 408 and the storage system configuration tool 402.

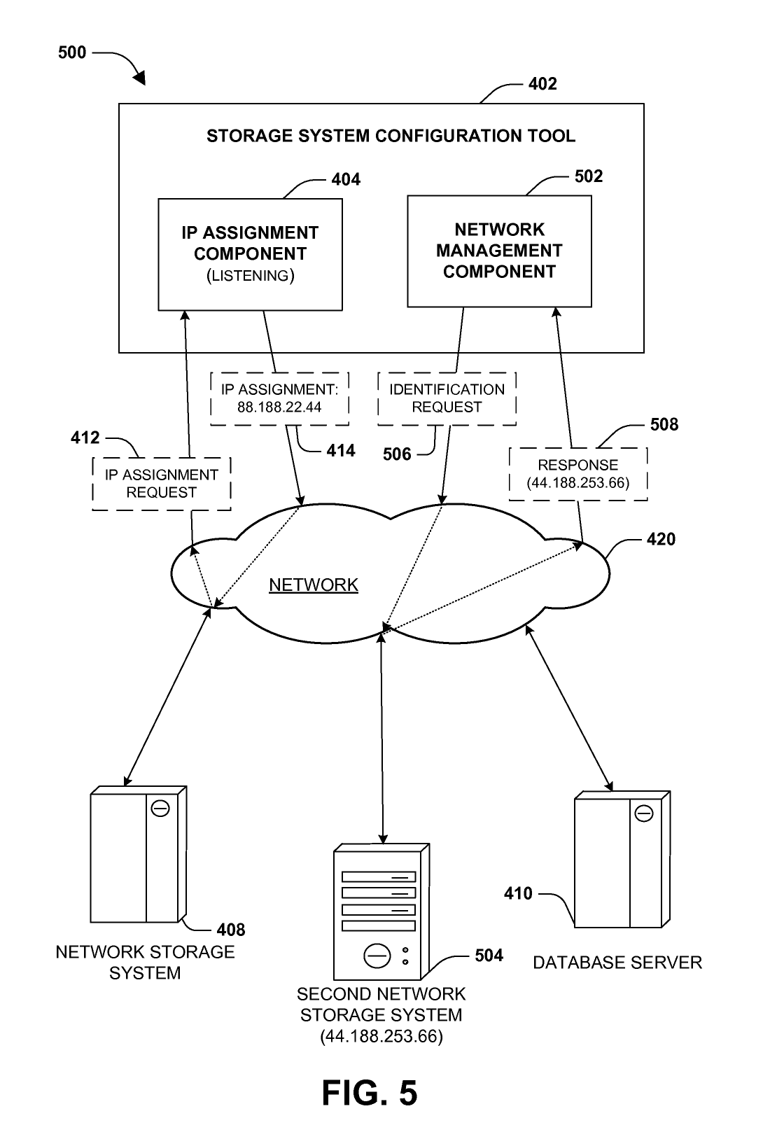

FIG. 5 illustrates an example of a system 500 for configuring one or more network storage systems within a network 420. The system 500 comprises a storage system configuration tool 402 connected to the network 420. The storage system configuration tool 402 comprises an IP assignment component 404 configured to listen for IP assignment requests over the network 420 if the network 420 does not comprise an IP assignment server. For example, the IP assignment component 404 may detect an IP assignment request 412 as originating from a network storage system 408. The IP assignment component 404 may assign an IP address (e.g., IP assignment 414 of 88.188.22.44) to the network storage system 408. In this way, configuration access may be provided to the network storage system 408 using the IP address.

The system 500 may comprise a network management component 502. The network management component 502 may be configured to send one or more identification requests over the network 420. For example, the network management component 502 may be configured to scan a range of IP addresses associated with the network 420 utilizing SNMP functionality. In an example, a second network storage system 504 may receive an identification request 506 originating from the network management component 502 over the network 420. The second network storage system 504 may have a previously assigned IP address (e.g., 44.188.253.66), which may be within the range of IP addressed scanned by the network management component 502. The second network storage system 504 may provide a response 508 to the request (e.g., the response 508 may provide information about the second network storage system 504, such as the previously assigned IP address). The network management component 502 may be configured to receive the response 508. Responsive to the network management component 502 identifying the second network storage system 504 as a network storage system, the network management component 502 may be configured to provide configuration access to the second network storage system 504 based upon the previously assigned IP address. For example, network storage configuration may be pushed to the second network storage system 504. In this way, the IP assignment component 404 and/or network management component 502 may detect and/or configure network storage systems over the network 420.

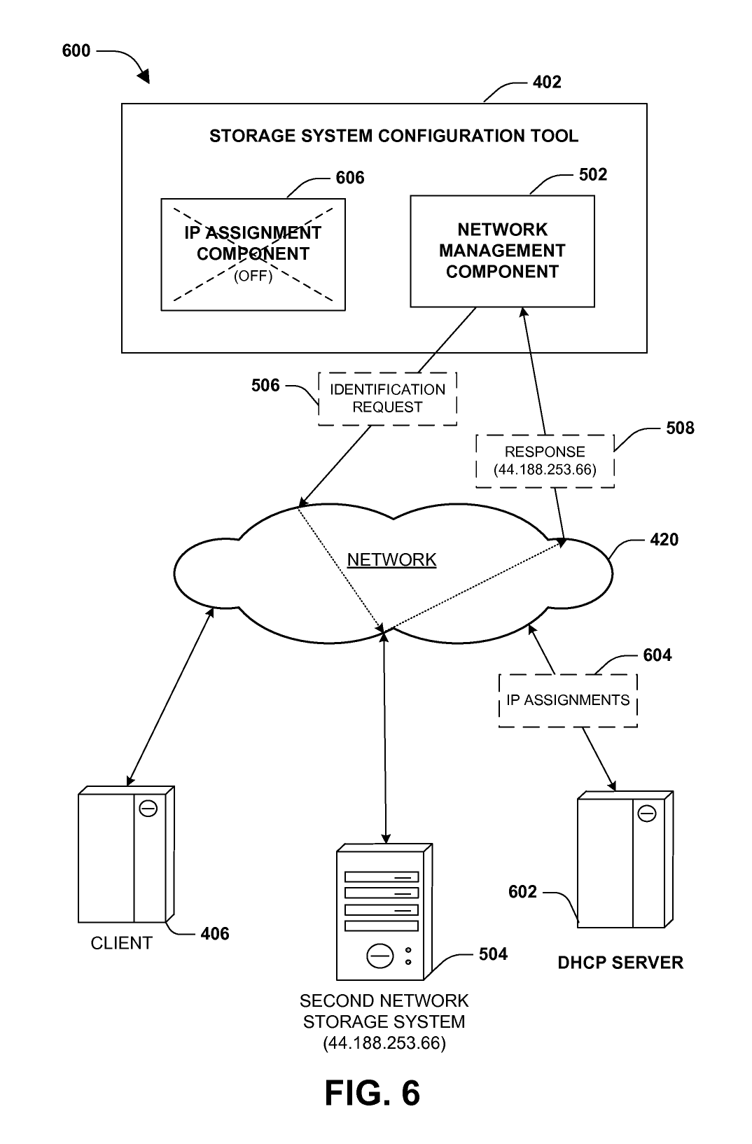

FIG. 6 illustrates an example of a system 600 for configuring a network storage system within a network 420. The system 600 comprises a storage system configuration tool 402 connected to the network 420. The storage system configuration tool 402 comprises an IP assignment component 606 and/or a network management component 502. The storage system configuration tool 402 may be configured to determine whether the network 420 comprises an IP assignment server, such as the DHCP server 602. Responsive to identifying the DHCP server 602, the storage system configuration tool 402 may be configured to shut off the IP assignment component 606, such that the IP assignment component 606 refrains from listening over the network for IP assignment requests because the DHCP server 602 may already be assigning IP addresses to devices within the network 420 (e.g., IP assignments 604).

The network management component 502 may be configured to scan the network 420 for network storage systems based upon IP address information from the DHCP server 602, such as a portion of a DHCP subnet. For example, the network management component 502 may send one or more identification requests over the network 420, such as an identification request 506 that is received by a second network storage system 504. The network management component 502 may receive a response 508 from the second network storage system 504, and may provide configuration access to the second network storage system 504 based upon information comprised within the response 508.

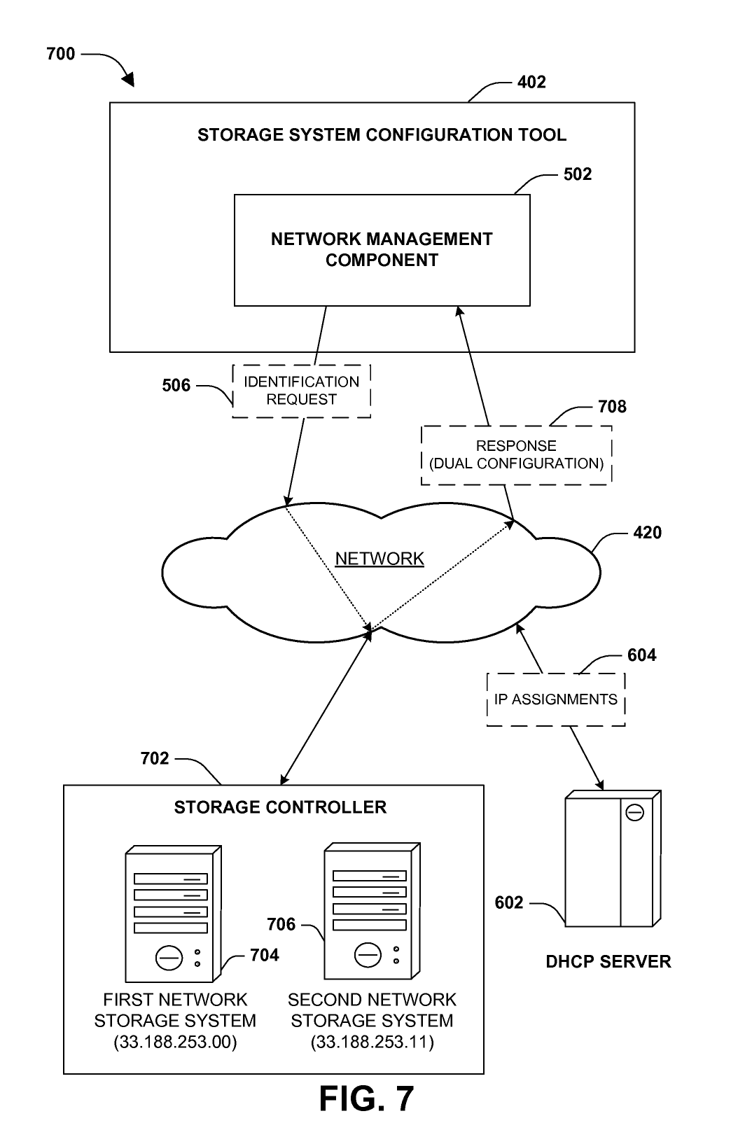

FIG. 7 illustrates an example of a system 700 for configuring one or more network storage systems within a network 420. The system 700 comprises a storage system configuration tool 402. The storage system configuration tool 402 may comprise a network management component 502. The network management component 502 may be configured to send one or more identifications requests over the network 420 to scan for one or more network storage systems. For example, a storage controller 702 may receive an identification request 506 over the network. The storage controller 702 may comprise a first network storage system 704 and a second network storage system 706. The first network storage system 704 may have a previously assigned IP address of 33.188.253.00 that was assigned by a DHCP server 602 connected to the network 420. The second network storage system 706 may have a previously assigned IP address of 33.188.253.11 that was assigned by the DHCP server 602.

The network management component 502 may receive a response 708 from the storage controller 702 (e.g., a first response from the first network storage system 704 and/or a second response from the second network storage system 706). The storage system configuration tool 402 may be configured to determine whether the first network storage system 704 and/or the second network storage system 706 may be configured according to a single storage controller configuration or a dual storage controller configuration. For example, the storage system configuration tool 402 may determine that the first network storage system 704 and the second network storage system 706 are configured according to the dual storage controller configuration because the storage controller 702 hosts both the first network storage system 704 and the second network storage system 706 (e.g., the first network storage system 704 and the second network storage system 706 may be configured within the storage controller 702 according to a high availability (HA) configuration, such that the second network storage system 706 serves as a backup storage system for the first network storage system 704). Accordingly, configuration access may be provided to the first network storage system 704 and/or the second network storage system 706 (e.g., both network storage systems may be configured contemporaneously) based upon the dual storage controller configuration (e.g., a first system name may be assigned to the first network storage system 704, a second system name may be assigned to the second network storage system 706, a network interface may be assigned to the pair of network storage systems, a domain name may be assigned to the pair of network storage systems, etc.).

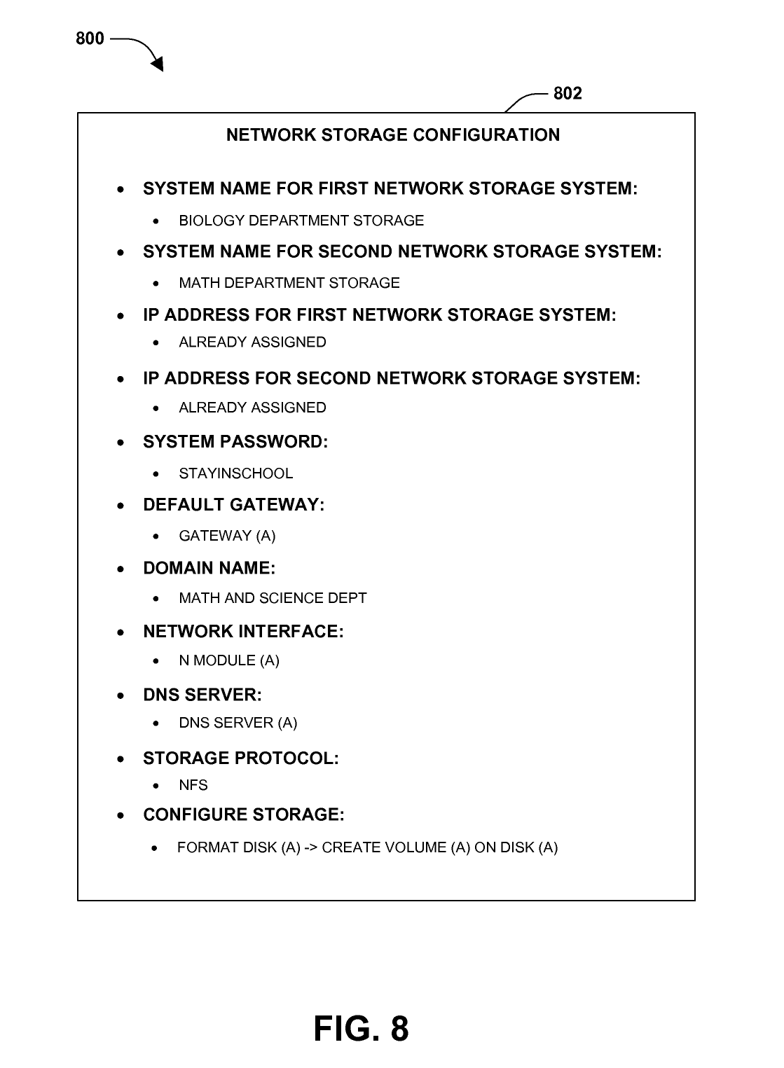

FIG. 8 illustrates an example 800 of a network storage configuration 802. One or more network storage systems may be detected over a network (e.g., the first network storage system 704 and the second network storage system 706 may be detected over network 420, as illustrated in example 700 of FIG. 7). Because the first network storage system 704 and the second network storage system 706 may initially lack configuration data, the network storage configuration 802 may be pushed to the first network storage system 704 and the second network storage system 706. For example, the network storage configuration 802 may specify a system name for the first network storage system 704, a system name for a second network storage system 706, an IP address for the first network storage system 704, an IP address for the second network storage system 706, a system password, a default gateway, a domain name, a network interface, a DNS server, one or more storage protocols (.g., NFS, CIFS, iSCSI, etc.), storage configuration (e.g., a format instruction for a disk, a create volume instruction, etc.), and/or a variety of configuration information for the first network storage system 704, the second network storage system 706, and/or the storage controller 702.

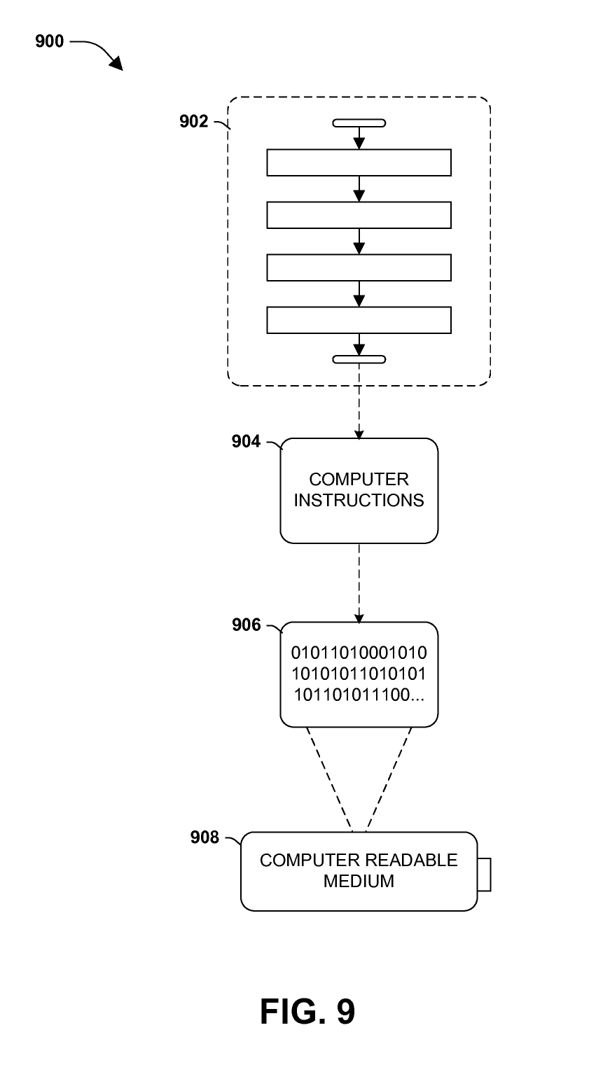

Still another embodiment involves a computer-readable medium comprising processor-executable instructions configured to implement one or more of the techniques presented herein. An example embodiment of a computer-readable medium or a computer-readable device that is devised in these ways is illustrated in FIG. 9, wherein the implementation 900 comprises a computer-readable medium 908, such as a CD-R, DVD-R, flash drive, a platter of a hard disk drive, etc., on which is encoded computer-readable data 906. This computer-readable data 906, such as binary data comprising at least one of a zero or a one, in turn comprises a set of computer instructions 904 configured to operate according to one or more of the principles set forth herein. In some embodiments, the processor-executable computer instructions 904 are configured to perform a method 902, such as at least some of the exemplary method 300 of FIG. 3, for example. In some embodiments, the processor-executable instructions 904 are configured to implement a system, such as at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computer-readable media are devised by those of ordinary skill in the art that are configured to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component is localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A system for configuring a network storage system within a network using a storage system configuration tool hosted by a computing device within the network, comprising:
a storage system configuration tool comprising:
an IP assignment component configured to:
listen for IP assignment requests over a network;
responsive to identifying an IP assignment request issued by a device connected to the network, determine whether the device comprises a network storage system; and
responsive to the device comprising a network storage system:
assign an IP address to the network storage system; and
provide configuration access to the network storage system based upon the IP address.

2. The system of claim 1, the IP assignment component comprising DHCP functionality.

3. The system of claim 1, the storage system configuration tool comprising:
a network device management component configured to:
send one or more identification requests over the network; and
responsive to receiving a response identifying a second network storage system having a previously assigned IP address, provide configuration access to the second network storage system based upon the previously assigned IP address.

4. The system of claim 3, the network device management component comprising SNMP functionality.

5. The system of claim 1, the storage system configuration tool configured to:
determine whether the network comprises an IP assignment server; and
responsive to determining that the network does not comprise the IP assignment server, invoking the IP assignment component to listen for IP assignment requests, otherwise refraining from invoking the IP assignment component to listen for IP assignment requests.

6. The system of claim 1, the IP assignment component configured to:
determine that the device corresponds to the network storage system based upon a first portion of a MAC address for the device corresponding to a network storage system manufacturer code.

7. The system of claim 1, the storage system configuration tool configured to:
provide a graphical user interface for configuring the network storage system over the network without using a local non-network connection to the network storage system.

8. The system of claim 1, the storage system configuration tool configured to:
determine whether the network storage system corresponds to a single storage controller configuration or a dual storage controller configuration, the dual storage controller configuration corresponding to the network storage system and a second network storage system hosted within a single storage controller.

9. The system of claim 8, the IP assignment component configured to:
provide configuration access to the network storage system based upon whether the network storage system corresponds to the single storage controller configuration or to the dual storage controller configuration.

10. The system of claim 7, the graphical user interface configured to:
provide configuration for at least one of a system name, a system password, a default gateway, a domain name, a network interface, a DNS server, storage device configuration, storage volume configuration, or a storage protocol for the network storage system.

11. A system for configuring a network storage system within a network using a storage system configuration tool hosted by a computing device within the network, comprising:
a storage system configuration tool comprising:
a network device management component configured to:
send one or more identification requests over a network; and
responsive to receiving a response identifying a network storage system having a previously assigned IP address, provide configuration access to the network storage system based upon the previously assigned IP address.

12. The system of claim 11, the storage system configuration tool comprising:
an IP assignment component configured to:
listen for IP assignment requests over the network;
responsive to identifying an IP assignment request issued by a device connected to the network, determine whether the device comprises a second network storage system; and
responsive to the device comprising a second network storage system:
assign an IP address to the second network storage system; and
provide configuration access to the second network storage system based upon the IP address.

13. The system of claim 11, the network device management component comprising SNMP functionality.

14. The system of claim 12, the storage system configuration tool configured to:
determine whether the network comprises an IP assignment server; and
responsive to determining that the network does comprise the IP assignment server, refraining from invoking the IP assignment component to listen for IP assignment requests.

15. The system of claim 11, the network device management component configured to:
push a network storage configuration to the network storage device over the network; and
send a reboot instruction to the network storage device to perform a reboot based upon the network storage configuration.

16. The system of claim 12, the IP assignment component configured to:
push a network storage configuration to the second network storage device over the network;
send an IP address save instruction to the second network storage device over the network, the IP address save instruction indicating that the second network storage device is to save the IP address assigned to the second network storage device for utilization after a reboot; and
send a reboot instruction to the second network storage device to perform the reboot based upon the network storage configuration.

17. A method for configuring a network storage system within a network, comprising:
responsive to determining that a network does not comprise an IP assignment server:
listening for IP assignment requests over the network;
responsive to identifying an IP assignment request issued by a device connected to the network, determining whether the device comprises a network storage system; and
responsive to the device comprising a network storage system:
assigning an IP address to the network storage system; and
providing configuration access to the network storage system based upon the IP address.

18. The method of claim 17, comprising:
sending one or more identification requests over the network; and
responsive to receiving a response identifying a second network storage system having a previously assigned IP address, providing configuration access to the second network storage system based upon the previously assigned IP address.

19. The method of claim 17, comprising:
pushing a network storage configuration to the network storage device over the network;
sending an IP address save instruction to the network storage device over the network, the IP address save instruction indicating that the network storage device is to save the IP address assigned to the network storage device for utilization after a reboot; and
send a reboot instruction to the network storage device to perform the reboot based upon the network storage configuration.

20. The method of claim 18, comprising:
pushing a network storage configuration to the second network storage device over the network; and
send a reboot instruction to the second network storage device to perform a reboot based upon the network storage configuration.
